(19) United States
(12) Patent Application Publication
(10) Pub. No.: US 2024/0299847 A1
(43) Pub. Date: Sep. 12, 2024

(54) INFORMATION TRANSFER METHOD AND APPARATUS, STORAGE MEDIUM, ELECTRONIC DEVICE, AND PROGRAM PRODUCT

(71) Applicant: Tencent Technology (Shenzhen) Company Limited, Shenzhen (CN)

(72) Inventors: Chenghao YE, Shenzhen (CN); Ziyi Wang, Shenzhen (CN)

(21) Appl. No.: 18/669,390

(22) Filed: May 20, 2024

Related U.S. Application Data
(63) Continuation of application No. PCT/CN2023/094139, filed on May 15, 2023.

(30) Foreign Application Priority Data
Jul. 28, 2022 (CN) 202210899831.1

(51) Int. Cl. A63F 13/537; A63F 13/426

(52) U.S. Cl. CPC A63F 13/537; A63F 13/426

(57) ABSTRACT

This application discloses an information transfer method performed at an electronic device. The method includes: displaying a virtual scene of a virtual game in which a first virtual character is currently located; in accordance with a first operation performed by the first virtual character, determining that the first virtual character triggers a first type of information transfer condition; and in accordance with the first type of information transfer condition, displaying a first virtual information carrier in the virtual scene, the first virtual information carrier being configured for transferring information specified by the first virtual character and associated with the virtual scene to a second virtual character. This application resolves the technical problem of low information transfer efficiency.

### CROSS-REFERENCE TO RELATED APPLICATIONS

This application is a continuation application of PCT Patent Application No. PCT/CN2023/094139, entitled “INFORMATION TRANSFER METHOD AND APPARATUS, STORAGE MEDIUM, ELECTRONIC DEVICE, AND PROGRAM PRODUCT” filed on May 15, 2023, which claims priority to Chinese Patent Application No. 202210899831.1, entitled “INFORMATION TRANSFER METHOD AND APPARATUS, STORAGE MEDIUM, ELECTRONIC DEVICE, AND PROGRAM PRODUCT” and filed with the China National Intellectual Property Administration on Jul. 28, 2022, both of which are incorporated herein by reference in their entirety.

### FIELD OF THE TECHNOLOGY

This application relates to the field of computers, and specifically, to information transfer.

### BACKGROUND OF THE DISCLOSURE

With the rapid development of virtual games, more users are paying more attention to user experience during the game. Especially, whether information transfer during the game can be as efficient as in real life is also one of the important factors affecting gaming experience of the users.

Information transfer in the related art usually relies on the signal function provided by the virtual games for the users. The users can implement information transfer through flashing signals. However, this information transfer manner not only considers the capability of the users to understand the signals, but also makes it difficult to cope with an increasing number of game elements in the virtual games. For example, when the users search many virtual scenes for resources, the users usually cannot well remember the searched or unsearched virtual scenes marked by the signals due to the large number of virtual scenes. This leads to a repeated search of the virtual scenes that have already been searched.

The reason is that this information transfer manner of signals is low in efficiency. Therefore, there is a problem of low information transfer efficiency in the related art.

In view of the foregoing problem, no effective solution has been provided yet.

### SUMMARY

Embodiments of this application provide an information transfer method and apparatus, a storage medium, and an electronic device, to at least resolve the technical problem of low information transfer efficiency.

According to an aspect of the embodiments of this application, an information transfer method is performed by an electronic device, the method including: displaying a virtual scene of a virtual game in which a first virtual character is currently located; in accordance with a first operation performed by the first virtual character, determining that the first virtual character triggers a first type of information transfer condition; and in accordance with the first type of information transfer condition, displaying a first virtual information carrier in the virtual scene, the first virtual information carrier being configured for transferring information specified by the first virtual character and associated with the virtual scene to a second virtual character.

According to another aspect of the embodiments of this application, a non-transitory computer-readable storage medium is further provided, the storage medium being configured to store a computer program, the computer program, when executed by a processor of an electronic device, causing the electronic device to perform the foregoing information transfer method.

According to still another aspect of the embodiments of this application, an electronic device is further provided, including a memory, a processor, and a computer program stored in the memory that, when executed by the processor, causing the electronic device to perform the foregoing information transfer method through the computer program.

In the embodiments of this application, a virtual scene in which a first virtual character is currently located is displayed, the virtual scene being a scene in a virtual game in which the first virtual character participates; and a first virtual information carrier triggered by the first virtual character is displayed in the virtual scene, the first virtual information carrier being configured for transferring information specified by the first virtual character and associated with the virtual scene. The manner of using the virtual information carrier to transfer physical information ensures stability of information transfer and further improves specificity of information transfer by combining the information transfer with the virtual scene and the virtual character, thereby achieving the objective of stably transferring specified information, achieving the technical effect of improving information transfer efficiency, and resolving the technical problem of low information transfer efficiency.

### BRIEF DESCRIPTION OF THE DRAWINGS

FIG. 1 is a schematic diagram of an application environment of an exemplary information transfer method according to an embodiment of this application.

FIG. 2 is a schematic flowchart of an exemplary information transfer method according to an embodiment of this application.

FIG. 3 is a schematic diagram of an exemplary information transfer method according to an embodiment of this application.

FIG. 4 is a schematic diagram of another exemplary information transfer method according to an embodiment of this application.

FIG. 5 is a schematic diagram of another exemplary information transfer method according to an embodiment of this application.

FIG. 6 is a schematic diagram of another exemplary information transfer method according to an embodiment of this application.

FIG. 7 is a schematic diagram of another exemplary information transfer method according to an embodiment of this application.

FIG. 8 is a schematic diagram of another exemplary information transfer method according to an embodiment of this application.

FIG. 9 is a schematic diagram of another exemplary information transfer method according to an embodiment of this application.

FIG. 10 is a schematic diagram of another exemplary information transfer method according to an embodiment of this application.

FIG. 11 is a schematic diagram of another exemplary information transfer method according to an embodiment of this application.

FIG. 12 is a schematic diagram of another exemplary information transfer method according to an embodiment of this application.

FIG. 13 is a schematic diagram of another exemplary information transfer method according to an embodiment of this application.

FIG. 14 is a schematic diagram of another exemplary information transfer method according to an embodiment of this application.

FIG. 15 is a schematic diagram of another exemplary information transfer method according to an embodiment of this application.

FIG. 16 is a schematic diagram of another exemplary information transfer method according to an embodiment of this application.

FIG. 17 is a schematic diagram of another exemplary information transfer method according to an embodiment of this application.

FIG. 18 is a schematic diagram of another exemplary information transfer method according to an embodiment of this application.

FIG. 19 is a schematic diagram of another exemplary information transfer method according to an embodiment of this application.

FIG. 20 is a schematic diagram of an exemplary information transfer apparatus according to an embodiment of this application.

FIG. 21 is a schematic structural diagram of an exemplary electronic device according to an embodiment of this application.

### DESCRIPTION OF EMBODIMENTS

To make a person skilled in the art better understand solutions of this application, the technical solutions in embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

In the specification, claims, and accompanying drawings of this application, the terms “first”, “second”, and the like are intended to distinguish between similar objects but do not necessarily indicate a specific order or sequence. The data termed in such a way are interchangeable in proper circumstances, so that the embodiments of this application described herein can be implemented in other orders than the order illustrated or described herein. Moreover, the terms “include”, “contain”, and any other variants thereof mean to cover the non-exclusive inclusion. For example, a process, method, system, product, or device that includes a list of operations or units is not necessarily limited to those operations or units that are clearly listed, but may include other operations or units not expressly listed or inherent to such a process, method, system, product, or device.

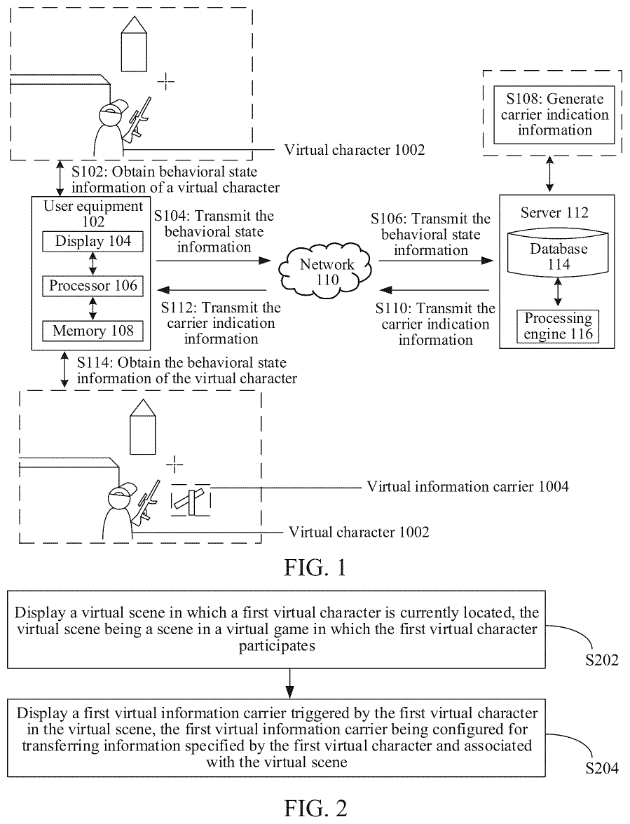

According to an aspect of the embodiments of this application, an information transfer method is provided. In some embodiments, as an exemplary implementation, the information transfer method may be, but is not limited to, applied to an environment shown in FIG. 1. The information transfer method may be performed by a computer device, where the computer device may, but is not limited to, include a user equipment 102 and a server 112. The user equipment 102 may include, but is not limited to, a display 104, a processor 106, and a memory 108. The server 112 includes a database 114 and a processing engine 116.

A specific process may be as the following operations:
S102: The user equipment 102 obtains behavioral state information of a virtual character 1002.
S104 and S106: Transmit the behavioral state information of the virtual character 1002 to the server 112 through a network 110.
S108: The server 112 retrieves information corresponding to an information transfer condition from the database 114, compares the information corresponding to the information transfer condition with the behavioral state information through the processing engine 116, and generates carrier indication information when an information similarity between the information corresponding to the information transfer condition and the behavioral state information is greater than or equal to a target threshold.
S110 to S114: Transmit the carrier indication information to the user equipment 102 through the network 110, and the user equipment 102 uses the carrier indication information to generate a virtual information carrier 1004 through the processor 106, displays the virtual information carrier 1004 on the display 108, and stores the virtual information carrier 1004 in the memory 104.

In addition to the example shown in FIG. 1, the foregoing operations may be completed by a server or a client alone, or may be completed by the server and the client in collaboration. For example, the user equipment 102 performs operations such as comparing the behavioral state information and generating the carrier indication information, thereby reducing a processing pressure on the server. The user equipment 102 includes, but is not limited to, a handheld device (such as a mobile phone), a laptop computer, a desktop computer, an in-vehicle device, or the like. This application does not limit the specific implementation of the user equipment 102.

In some embodiments, as an exemplary implementation, as shown in FIG. 2, the information transfer method includes the following operations.
S202: Display a virtual scene in which a first virtual character is currently located, the virtual scene being a scene in a virtual game in which the first virtual character participates.
S204: Display a first virtual information carrier triggered by the first virtual character in the virtual scene, the first virtual information carrier being configured for transferring information specified by the first virtual character and associated with the virtual scene.

In this embodiment, the information transfer method may be, but is not limited to, applied to a team-type virtual game scene. In the team-type virtual game scene, there are usually many requirements for information transfer between users, to use the information transfer method to help information transfer between the users, which improves cooperation efficiency or achieves other purposes. An information transfer manner may be, but is not limited to, two types: requiring active input by a user, or preset by a system to automatically prompt the user, such as a microphone, preset voice, text, and facial expression.

However, in some specific scenes, the information transfer manner is insufficient to meet more diversified requirements of the user. For example, in a scene of searching for supplies, a problem of repeated search usually can only be avoided as much as possible by roughly dividing a region between the users before searching for the supplies. This is because in a house search process, the users do not know each other's current position, and cannot promptly transfer information to teammates about whether the region has been searched. In other words, the time when a plurality of users arrive at a position varies and there is a span.

In this embodiment, in the manner in which the virtual information carrier is generated through triggering by the virtual character, information transfer to any virtual scene is completed, and due to a physical attribute of the virtual information carrier, more stable information output may be provided for the user and the information transfer efficiency is improved.

In some embodiments, a triggering manner of the virtual character may include, but is not limited to, triggering an information transfer condition, such as active triggering and passive triggering. Using the active triggering as an example, the virtual character actively performs operations such as placing the virtual information carrier to trigger generation and display of the virtual information carrier; and then using the passive triggering as an example, when an operation performed by the virtual character or a state of the virtual character meets a passive triggering condition, the generation and the display of the virtual information carrier are triggered.

In this embodiment, to further improve the information transfer efficiency, it can, but is not limited to, set a more automated information transfer function. For example, the user may automatically mark any virtual scene, so that when other users or the user himself enters or approaches the marked virtual scene again, relevant content of the automated marker is automatically prompted, such as prompting that a current virtual scene has been searched. However, considering that a virtual game has higher requirements for simulation, which means that functions unachievable in a real scene are avoided in a virtual game scene, emergence of the automated marker may cause some damage to the simulation.

Further, in this embodiment, the automatic marking function is indirectly implemented with the virtual information carrier, and since the virtual information carrier also has the same performance in the real scene (such as using a light stick to transfer specific information), this not only reduces the damage to the simulation of the virtual game, but also provides the user with a more stable and efficient information transfer manner.

In addition, considering that different users have different experience requirements for the virtual game, the user may pre-configure the information transfer manner in the virtual game, such as using the virtual information carrier for information transfer, or using automated marking for information transfer; or different modes of virtual games may be provided to the user. The information transfer manner allowed by different modes of virtual games may be, but not limited to, different. For example, in a mode A, only the virtual information carrier is allowed for information transfer, and in a mode B, only automated marking is allowed for information transfer.

In this embodiment, the first virtual character may be, but not limited to, understood as one of the characters participating in a virtual game, or the only virtual character participating. If the characters participating in a virtual game include a character A, a character B, and a character C, the first virtual character may be a character among the character A, the character B, and the character C. Alternatively, if the characters participating in a virtual game only include a character D, and other characters are non-player characters (NPCs), the first virtual character may be the character D.

Further, in some embodiments, for example, when the character A triggers the information transfer condition, the first virtual information carrier triggered by the first virtual character is displayed in the virtual scene. The first virtual information carrier may be, but is not limited to, understood as an information carrier specified by the character A and associated with the virtual scene, and information to be transferred by the first virtual information carrier is information that the character A intends to transfer to a friendly character (assuming that the character A and the character B are in the same camp); or the information to be transferred by the first virtual information carrier is information that the character A intends to warn himself, such as marking that the virtual scene has been searched to avoid a repeated search.

In this embodiment, the virtual scene may be, but is not limited to, understood as an overall scene of a virtual game, or may be, but is not limited to, understood as a partial scene of a virtual game. If a virtual game includes a plurality of virtual buildings, the virtual scene may be, but is not limited to, a scene in which one of the plurality of virtual buildings is located.

Further, in some embodiments, as shown in FIG. 3, after performing a search operation on a virtual building 304, a first virtual character 302 chooses to trigger the information transfer condition, and then generates a first virtual information carrier 306, thereby prompting himself or other first virtual characters that a virtual scene in which the virtual building 304 is located has been searched.

In this embodiment, the information transfer condition may be, but is not limited to, understood as a condition actively or passively triggered by the first virtual character to generate the first virtual information carrier for information transfer. Using the active triggering as an example, the first virtual character actively performs a triggering operation on a first target object A that is held or exists in the virtual scene, and then determines that the information transfer condition is triggered by the first virtual character; and using the passive triggering as an example, when a behavioral operation or a character state of the first virtual character meets a preset condition, it is determined that the information transfer condition is triggered by the first virtual character, or when the first virtual character approaches a second target object existing in the virtual scene, it is determined that the information transfer condition is triggered by the first virtual character.

In this embodiment, the first virtual information carrier is configured for transferring information specified by the first virtual character and associated with the virtual scene. For example, information A specified by the first virtual character includes “there is a trap”, and target information obtained after the information A is associated with the virtual scene is “there is a trap in the virtual scene”. Similarly, information B specified by the first virtual character includes “searched”, and target information obtained after the information B is associated with the virtual scene is “the virtual scene has been searched”.

In addition, in this embodiment, to improve the user experience, it may further, but not limited to, open a customization function of the target information. For example, a player may perform various operations such as annotating, supplementing, and deleting on information content of the target information. Further, in some embodiments, for example, to avoid the target information being captured by a character in an enemy camp, it may, but not limited to, package the target information into pre-communicated internal words; or to increase importance of the first virtual character to the target information, it may, but not limited to, mark an importance level of the target information; or to improve interest of the target information, it may, but not limited to, add some interesting expressions, pictures, or videos to the target information.

The manner of using the virtual information carrier to transfer physical information ensures stability of information transfer and further improves specificity of information transfer by combining the information transfer with the virtual scene and the virtual character.

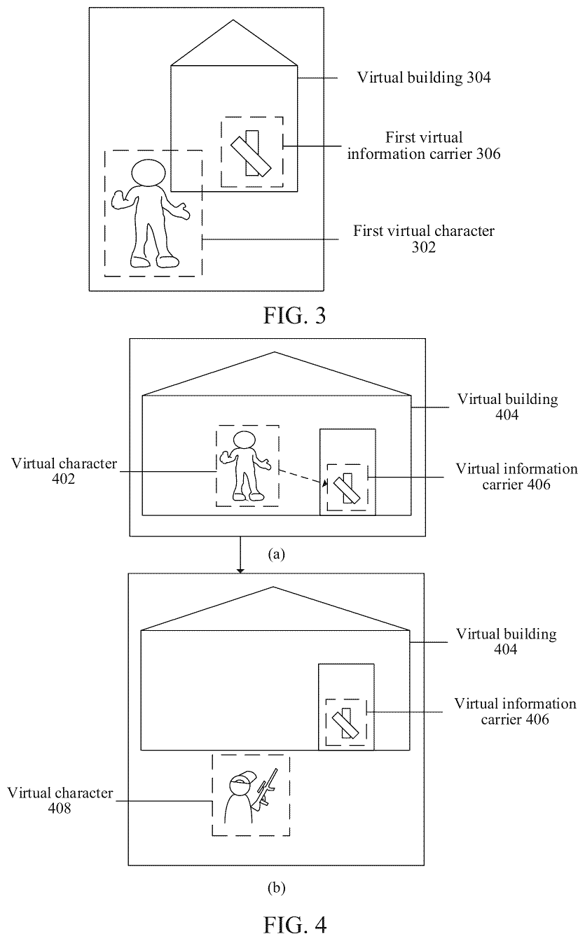

Further, in some embodiments, for example, as shown in FIG. 4, a virtual scene corresponding to a virtual building 404 in which a virtual character 402 is currently located is displayed. Further, as shown in (a) of FIG. 4, when the virtual character 402 triggers the information transfer condition, a virtual information carrier 406 is displayed in the virtual scene corresponding to the virtual building 404, where the virtual information carrier 406 is configured for transferring information specified by the virtual character 402 and associated with the virtual scene corresponding to the virtual building 404, such as target information “supplies in the virtual building 404 have been searched”. In addition, to help other virtual characters to learn the target information, the virtual character 402 may, but not limited to, choose to display the virtual information carrier 406 at an entrance of the virtual building 404, and then as shown in (b) of FIG. 4, before the virtual character 408 enters the virtual building 404, the virtual information carrier 406 is displayed on a client of the virtual character 408, thereby learning the target information and avoiding a problem of repeated search for the supplies in the virtual building 404.

Through this embodiment provided in this application, a virtual scene in which a first virtual character is currently located is displayed, the virtual scene being a scene in a virtual game in which the first virtual character participates; and a first virtual information carrier triggered by the first virtual character is displayed in the virtual scene, the first virtual information carrier being configured for transferring information specified by the first virtual character and associated with the virtual scene. The manner of using the first virtual information carrier to transfer physical information ensures stability of information transfer and further improves specificity of information transfer by combining the information transfer with the virtual scene and the first virtual character, thereby achieving the objective of stably transferring specific information, and achieving the technical effect of improving information transfer efficiency.

As an exemplary solution, after the displaying a virtual scene in which a first virtual character is currently located, the method includes:
determining that the first virtual character triggers a first type of information transfer condition when a first operation performed by the first virtual character is obtained, where the information transfer condition is a condition under which the first virtual information carrier is triggered to display.

In this embodiment, the first operation performed by the first virtual character may be, but is not limited to, a triggering operation performed on a target object, where the target object may be, but is not limited to, a prop held by the first virtual character or an existing object in the virtual scene.

In this embodiment, the first operation performed by the first virtual character may further be, but is not limited to, a preset behavioral operation. When the operation performed by the first virtual character matches the preset behavioral operation, it is deemed that the first virtual character performs the first operation.

In this embodiment, the first operation may further be, but is not limited to, associated with attribute information of the first virtual character. If the first operation is an operation of moving into a virtual scene, when the first operation performed by the first virtual character is obtained and the attribute information of the first virtual character meets an attribute information condition, it is automatically determined that the first virtual character triggers the first type of information transfer condition, where the information transfer condition is a condition under which the first virtual information carrier is triggered to display, and the first virtual information carrier is further generated, which improves the information transfer efficiency.

It is determined that the first virtual character triggers a first type of information transfer condition when a first operation performed by the first virtual character is obtained, where the information transfer condition is a condition under which the first virtual information carrier is triggered to display.

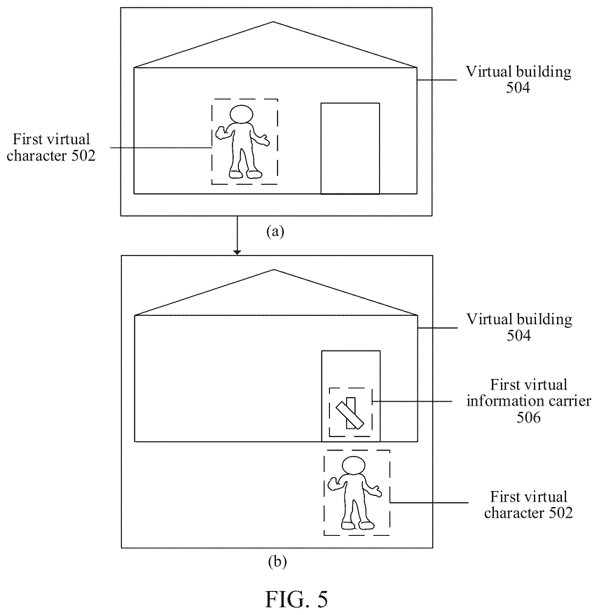

Further, in some embodiments, for example, as shown in FIG. 5, a virtual scene corresponding to a virtual building 504 in which a first virtual character 502 is currently located is displayed, as shown in (a) of FIG. 5. Further, as shown in (b) of FIG. 5, when it is obtained that the first virtual character has performed a search operation (first operation) on virtual supplies in the virtual building 504, it is determined that the first virtual character 502 triggers the first type of information transfer condition and generates a first virtual information carrier 506, or after the first virtual character 502 leaves the virtual scene corresponding to the virtual building 504, the first virtual information carrier 506 is generated to transfer information that the virtual supplies in the virtual building 504 have been searched.

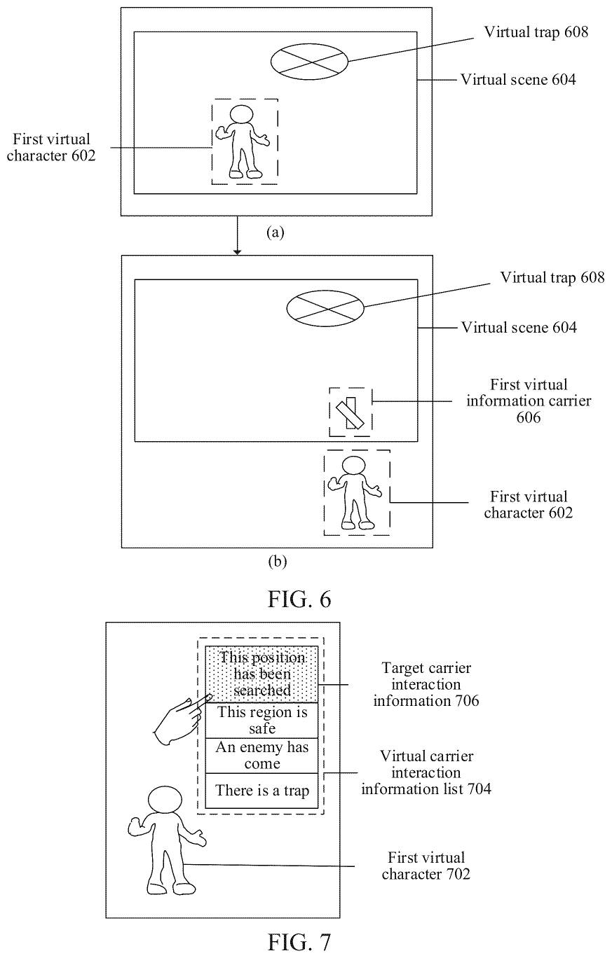

Again, in some embodiments, for example, as shown in FIG. 6, a virtual scene 604 in which a first virtual character 602 is currently located is displayed, and as shown in (a) of FIG. 6, the virtual scene 604 includes a virtual trap 608. Further, as shown in (b) of FIG. 6, when a marking operation (first operation) performed on the virtual trap 608 by the first virtual character 602 is obtained, it is determined that the first virtual character triggers the first type of information transfer condition, where the information transfer condition is a condition under which the first virtual information carrier is triggered to display, and a first virtual information carrier 606 is generated to transfer warning information of the virtual trap 608 in the virtual scene 604.

As an exemplary solution, the displaying a first virtual information carrier triggered by the first virtual character in the virtual scene includes:
S1: determining a first type of first virtual information carrier corresponding to the first type of information transfer condition, and a generation position of the first type of first virtual information carrier, where the generation position of the first type of first virtual information carrier is associated with the first operation; and
S2: displaying the first type of first virtual information carrier as the first virtual information carrier at the generation position of the first type of first virtual information carrier.

In this embodiment, different types of information transfer conditions may, but are not limited to, correspond to different types of first virtual information carriers. For example, the first virtual information carrier corresponding to the first type of information transfer condition is a prop A (the first type of the first virtual information carrier); or the first virtual information carrier corresponding to the first type of information transfer condition includes a plurality of types of first virtual information carriers such as a prop B and a prop C (the first type of the first virtual information carrier).

In this embodiment, the generation position of the first type of first virtual information carrier may be, but is not limited to, associated with the first operation, or associated with a position at which the first type of information transfer condition is triggered. For example, assuming that the first type of first virtual information carrier is a prop held by the first virtual character, and the first operation is a placement operation performed on the first type of first virtual information carrier, in response to the placement operation, a position at which the first type of first virtual information carrier is placed may be, but is not limited to, understood as the generation position of the first type of first virtual information carrier; or a position at which the first virtual character is located when the first type of information transfer condition is triggered is determined as the generation position of the first type of first virtual information carrier.

As an exemplary solution, after the displaying a virtual scene in which a first virtual character is currently located, the method includes:
S1: displaying a virtual carrier interaction information list; and
S2: determining that the first virtual character triggers a second type of information transfer condition when a second operation performed on target carrier interaction information in the virtual carrier interaction information list is obtained, where the information transfer condition is a condition under which the first virtual information carrier is triggered to display.

In this embodiment, to improve the diversity of information to be transferred, a variety of different exemplary information is provided for the user to transfer through the virtual carrier interaction information list.

The virtual carrier interaction information list is displayed; and it is determined that the first virtual character triggers the second type of information transfer condition when the second operation performed on target carrier interaction information in the virtual carrier interaction information list is obtained, where the information transfer condition is the condition under which the first virtual information carrier is triggered to display.

Further, in some embodiments, for example, as shown in FIG. 7, a virtual carrier interaction information list 704 associated with a first virtual character 702 is displayed. The virtual carrier interaction information list 704 includes a plurality of pieces of carrier interaction information, such as “this position has been searched”, “this region is safe”, “an enemy has come”, and “there is a trap here”. It is determined that the first virtual character 702 triggers the second type of information transfer condition when the second operation performed on target carrier interaction information 706 “this position has been searched” in the virtual carrier interaction information list 704 is obtained.

Through this embodiment provided in this application, the virtual carrier interaction information list is displayed; and it is determined that the first virtual character triggers the second type of information transfer condition when the second operation performed on target carrier interaction information in the virtual carrier interaction information list is obtained, where the information transfer condition is the condition under which the first virtual information carrier is triggered to display, thereby achieving the objective of providing the user with more diverse information choices to be transferred and achieving the technical effect of improving the diversity of information transfer.

As an exemplary solution, the displaying a first virtual information carrier triggered by the first virtual character in the virtual scene includes:
S1: determining a second type of first virtual information carrier corresponding to the second type of information transfer condition, and a generation position of the second type of first virtual information carrier, where the generation position of the second type of first virtual information carrier is associated with the second operation; and
S2: displaying the second type of first virtual information carrier as the first virtual information carrier at the generation position of the second type of first virtual information carrier.

In this embodiment, different types of information transfer conditions may, but are not limited to, correspond to different types of first virtual information carriers. For example, the first virtual information carrier corresponding to the second type of information transfer condition is a prop D (the second type of the first virtual information carrier); or the first virtual information carrier corresponding to the second type of information transfer condition includes a plurality of types of first virtual information carriers such as a prop E and a prop F (the second type of the first virtual information carrier).

In this embodiment, the generation position of the second type of first virtual information carrier may be, but is not limited to, associated with the second operation, or associated with a position at which the second type of information transfer condition is triggered. For example, assuming that the second operation is a drag operation performed on target carrier interaction information, in response to the drag operation, a final position to which the target carrier interaction information is dragged may be, but is not limited to, understood as the generation position of the second type of first virtual information carrier; and a position at which the first virtual character is located when the second type of information transfer condition is triggered is determined as the generation position of the second type of first virtual information carrier.

As an exemplary solution, after the displaying a virtual scene in which a first virtual character is currently located, the method further includes:
displaying a second virtual information carrier in the virtual scene, where the second virtual information carrier is an information carrier generated when a second virtual character participating in a virtual game triggers a target information transfer condition, and the second virtual information carrier is configured for transferring information specified by the second virtual character and associated with the virtual scene.

In this embodiment, the virtual information carriers generated by different virtual characters may be displayed on a client corresponding to the virtual character within a preset range. For example, the first virtual information carrier generated by a first virtual character A may be displayed on a client of the first virtual character A, or may be displayed on a client of a second virtual character B who also participates in the same virtual game.

As an exemplary solution, the displaying a second virtual information carrier in the virtual scene includes at least one of the following:
displaying the second virtual information carrier in the virtual scene when the second virtual character and the first virtual character belong to the same camp;
displaying encrypted information of the second virtual information carrier when the second virtual character and the first virtual character belong to different camps; and displaying the second virtual information carrier in the virtual scene in response to a first cracking operation on the encrypted information of the second virtual information carrier being successfully performed.

In this embodiment, the virtual information carriers generated by different virtual characters may be displayed on the client corresponding to the virtual character within the preset range, where the preset range may be, but is not limited to, other virtual characters in the same camp as the virtual character. However, to improve display comprehensiveness of the virtual information carrier, other virtual characters in different camps from the virtual character may be, but are not limited to, displayed in an encrypted manner.

The second virtual information carrier is displayed in the virtual scene when the second virtual character and the first virtual character belong to the same camp; encrypted information of the second virtual information carrier is displayed when the second virtual character and the first virtual character belong to different camps; and the second virtual information carrier is displayed in the virtual scene in response to a first cracking operation on the encrypted information of the second virtual information carrier being successfully performed.

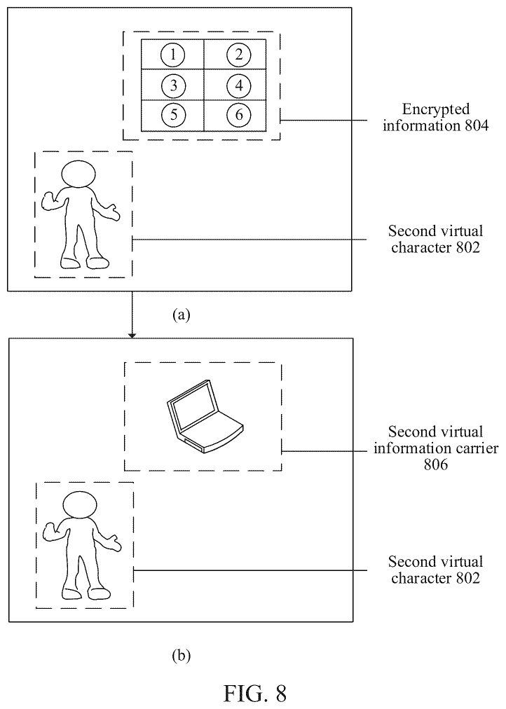

Further, in some embodiments, for example, as shown in FIG. 8, when a second virtual character 802 and the first virtual character belong to different camps, encrypted information 804 is displayed, as shown in (a) of FIG. 8. Further, as shown in (b) of FIG. 8, a second virtual information carrier 806 is displayed in the virtual scene in response to the first cracking operation on the encrypted information 804 being successfully performed.

Through this embodiment provided in this application, the second virtual information carrier is displayed in the virtual scene when the second virtual character and the first virtual character belong to the same camp; the encrypted information of the second virtual information carrier is displayed when the second virtual character and the first virtual character belong to different camps; and the second virtual information carrier is displayed in the virtual scene in response to the first cracking operation performed on the encrypted information of the second virtual information carrier, thereby achieving the objective of providing comprehensive display of the first virtual information carrier for various users and achieving the technical effect of improving the display comprehensiveness of the first virtual information carrier.

As an exemplary solution, after the displaying a second virtual information carrier in the virtual scene, the method further includes:
displaying target information when the first virtual character triggers an information display condition, where the target information is information specified by the second virtual character and associated with the virtual scene.

The target information is displayed when the first virtual character triggers an information display condition, where the target information is information specified by the second virtual character and associated with the virtual scene.

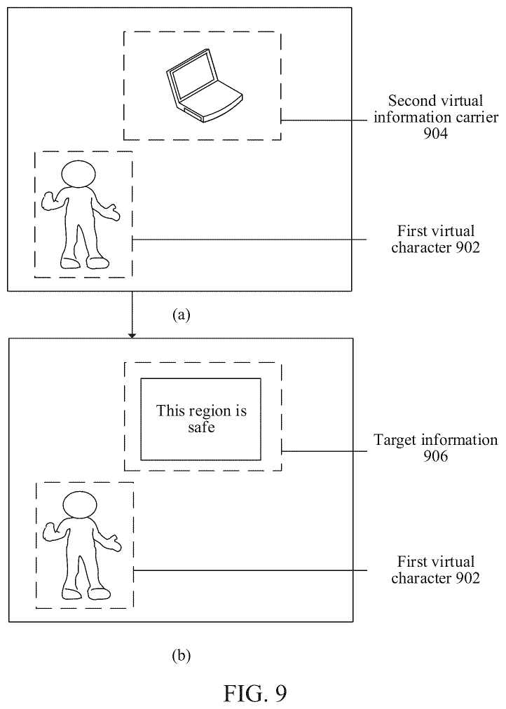

Further, in some embodiments, for example, as shown in FIG. 9, a second virtual information carrier 904 is displayed in a virtual scene in which a first virtual character 902 is located, as shown in (a) of FIG. 9. Further, as shown in (b) of FIG. 9, the target information 906 “this region is safe” is displayed when the first virtual character 902 triggers the information display condition, where the target information is the information specified by the second virtual character and associated with the virtual scene and may be specifically understood to represent that the virtual scene is safe.

As an exemplary solution, before the displaying target information to be transferred by the second virtual information carrier when the first virtual character triggers an information display condition, the method further includes at least one of the following:
determining that the first virtual character triggers the information display condition when the second virtual character and the first virtual character belong to the same camp;
displaying encrypted information of the target information when the second virtual character and the first virtual character belong to different camps; and displaying that the first virtual character triggers the information display condition when a second cracking operation on the encrypted information of the target information being successfully performed.

As an exemplary solution, before the displaying target information to be transferred by the second virtual information carrier when the first virtual character triggers an information display condition, the method further includes:
S1: obtaining a current position of the first virtual character; and
S2: determining that the first virtual character triggers the information display condition when a distance between the current position of the first virtual character and the second virtual information carrier is less than a threshold.

To improve the information transfer efficiency of the second virtual information carrier, when the current position of the first virtual character meets a trigger condition of the target information (the information display condition), it may, but is not limited to, automatically generate and display the target information.

Further, in some embodiments, for example, as shown in FIG. 9, the second virtual information carrier 904 is displayed in the virtual scene in which the first virtual character 902 is located, as shown in (a) of FIG. 9. Further, as shown in (b) of FIG. 9, the target information 906 “this area is safe” is displayed when the distance between the current position of the first virtual character 902 and the second virtual information carrier 904 is less than the threshold, where the target information is the information specified by the second virtual character and associated with the virtual scene and may be specifically understood to represent that the virtual scene is safe.

As an exemplary solution, before the displaying target information to be transferred by the second virtual information carrier when the first virtual character triggers an information display condition, the method includes:
determining that the first virtual character triggers the information display condition when the first virtual character collides with the second virtual information carrier.

In this embodiment, a first collider of the first virtual character and a second collider of the second virtual information carrier are obtained, and it is determined that the first virtual character triggers the information display condition when the first collider and the second collider collide.

As an exemplary solution, before the displaying target information to be transferred by the second virtual information carrier when the first virtual character triggers an information display condition, the method includes:
determining that the first virtual character triggers the information display condition when a third operation performed on the second virtual information carrier is obtained.

In this embodiment, the third operation performed on the second virtual information carrier may be, but is not limited to, an active operation performed on the second virtual information carrier, such as a selection operation, an attack (shooting) operation, and an obtaining operation.

As an exemplary solution, the displaying a first virtual information carrier triggered by the first virtual character in the virtual scene includes:
displaying N first virtual information carriers triggered by the first virtual character in the virtual scene, where N is a natural number, and the information specified by the first virtual character and associated with the virtual scene is associated with each of the N first virtual information carriers.

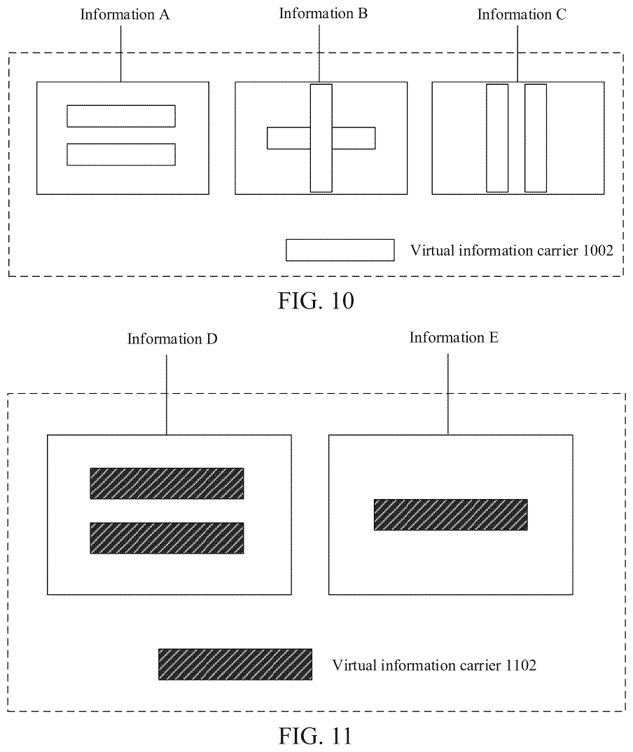

In this embodiment, to improve the diversity of information to be transferred, a variety of different exemplary information is provided for the user to transfer through the virtual carrier interaction information list. As shown in FIG. 10, by placing two virtual information carriers 1002 in different ways, different information, such as information A, information B, and information C, is transferred. In addition, different quantities of virtual information carriers may alternatively be, but are not limited to, configured for transferring different information. As shown in FIG. 11, a virtual information carrier 1102 is configured for transferring information E, and two virtual information carriers 1102 are configured for transferring information D. In addition, richer information transfer may be performed in combination with, but not limited to the quantity, types, and placement manners of the virtual information carriers.

Through this embodiment provided in this application, the first virtual information carriers triggered by the first virtual character are displayed in the virtual scene, where N is a natural number, and the information specified by the first virtual character and associated with the virtual scene is associated with each of the N first virtual information carriers, thereby achieving the objective of using a variety of first virtual information carriers to transfer diverse information and achieving the technical effect of improving the diversity of information transfer.

As an exemplary solution, after the displaying a first virtual information carrier triggered by the first virtual character in the virtual scene, the method further includes at least one of the following:
modifying the first virtual information carrier in response to a first modification instruction and displaying a modified first virtual information carrier in the virtual scene, where information to be transferred by the modified first virtual information carrier is different from the information specified by the first virtual character and associated with the virtual scene; or
modifying the information specified by the first virtual character and associated with the virtual scene in response to a second modification instruction to obtain modified specified information, and determining that information used by the first virtual information carrier to transfer is modified to the modified specified information.

In this embodiment, to improve the processing flexibility of transferred information, after the information has been transferred through the first virtual information carrier, the first virtual information carrier or the information may further be modified to transfer different information.

The first virtual information carrier is modified in response to the first modification instruction and the modified first virtual information carrier is displayed in the virtual scene, where the information to be transferred by the modified first virtual information carrier is different from the original information specified by the first virtual character and associated with the virtual scene.

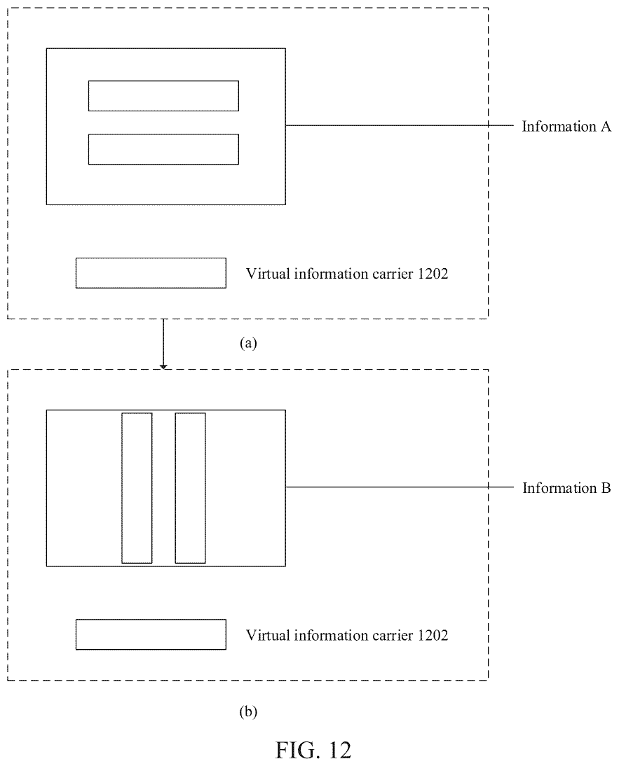

Further, in some embodiment, for example, as shown in FIG. 12, two virtual information carriers 1202 placed in parallel are displayed, as shown in (a) of FIG. 12, where the two virtual information carriers 1202 placed in parallel are configured for transferring the information A. Further, as shown in (b) of FIG. 12, a placement manner of the virtual information carrier 1202 is changed and two vertically placed virtual information carriers 1202 are displayed, where the two vertically placed virtual information carriers 1202 are configured for transferring the information B.

The information specified by the first virtual character and associated with the virtual scene is modified in response to the second modification instruction to obtain the modified specified information, and it is determined that the information used by the first virtual information carrier to transfer is modified to the modified specified information.

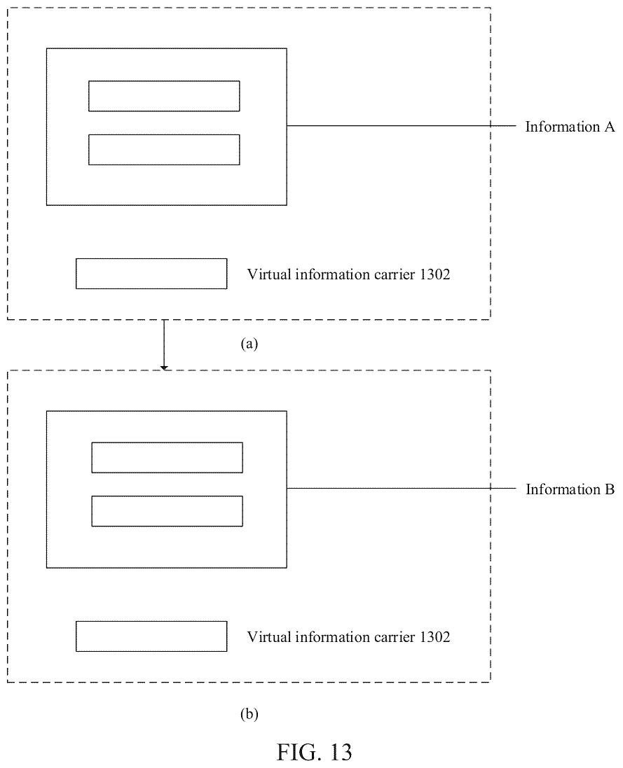

Further, in some embodiment, for example, as shown in FIG. 13, two virtual information carriers 1302 placed in parallel are displayed, as shown in (a) of FIG. 13, where the two virtual information carriers 1302 placed in parallel are configured for transferring the information A. Further, as shown in (b) of FIG. 13, information transferred by the two virtual information carriers 1302 placed in parallel is directly changed to the information B, and then the two virtual information carriers 1302 placed in parallel are displayed to transfer the information B.

Through this embodiment provided in this application, the first virtual information carrier is modified in response to the first modification instruction and the modified first virtual information carrier is displayed in the virtual scene, where the information to be transferred by the modified first virtual information carrier is different from the information specified by the first virtual character and associated with the virtual scene; and the information specified by the first virtual character and associated with the virtual scene is modified in response to the second modification instruction to obtain the modified specified information, and it is determined that the information used by the first virtual information carrier to transfer is modified to the modified specified information, thereby achieving the technical effect of improving the processing flexibility of transferred information.

As an exemplary solution, the displaying a first virtual information carrier triggered by the first virtual character in the virtual scene further includes at least one of the following:
displaying a virtual element mark triggered by the first virtual character in the virtual scene, where the virtual element mark is a virtual mark left after a target element is imprinted on a first target object in the virtual scene;
displaying a virtual prop triggered by the first virtual character in the virtual scene, where the virtual prop includes a static prop and a dynamic prop, the dynamic prop allows triggering playback of a virtual picture, and the virtual picture is configured for transferring the information specified by the first virtual character and associated with the virtual scene; and
displaying a second target object triggered by the first virtual character in the virtual scene, where the second target object is configured for dynamically transferring the information specified by the first virtual character and associated with the virtual scene.

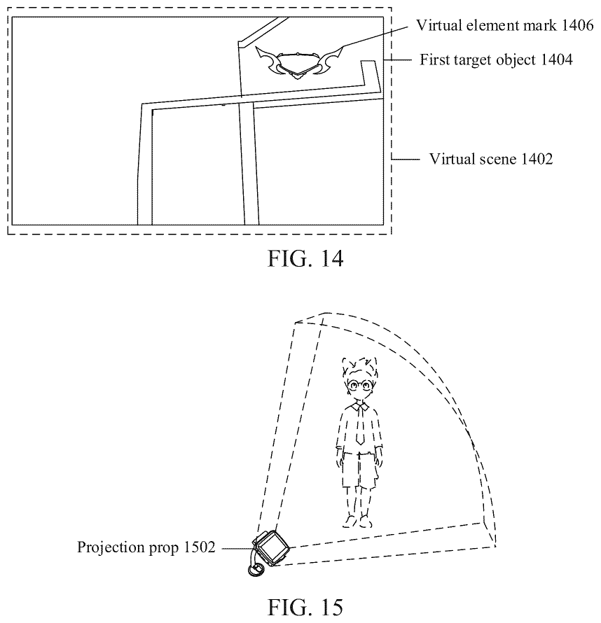

In this embodiment, the virtual element mark is a virtual mark left after the target element is imprinted on the first target object in the virtual scene. As shown in FIG. 14, a virtual element mark 1406 is a target element left after the target element is imprinted on a first target object 1404 (such as a wall) in a virtual scene 1402.

In this embodiment, the virtual prop includes a static prop and a dynamic prop, the dynamic prop allows triggering the playback of the virtual picture, and the virtual picture is configured for transferring the information specified by the first virtual character and associated with the virtual scene. As shown in FIG. 15, the dynamic prop is a projection prop 1502, which can play the virtual picture through projection, thereby transferring information in an intuitive way.

In this embodiment, the second target object may be, but is not limited to, understood as a consciousness body, a magic element, and the like in a fantasy game, to replace the first virtual character for dynamic information transfer.

As an exemplary solution, after the displaying a first virtual information carrier triggered by the first virtual character in the virtual scene, the method includes:
displaying the information specified by the first virtual character and associated with the virtual scene, where the information specified by the first virtual character and associated with the virtual scene includes at least one of the following:
safety information of a current environment of the virtual scene or a target space associated with the virtual scene;
situation information of virtual resources currently owned by the virtual scene or the target space;
historical behavior information of the virtual scene or the target space being operated;
indication direction information starting from the virtual scene or the target space; and
reference information for completing a virtual task associated with the virtual scene or the target space.

In this embodiment, for example, the safety information of a current environment of the virtual scene or a target space associated with the virtual scene is whether the current environment of the target space associated with the virtual scene is safe, whether there is a trap, or whether there is an enemy character.

In this embodiment, for example, the situation information of virtual resources currently owned by the virtual scene or the target space is a detailed list of the virtual resources currently owned in the target space associated with the virtual scene, whether the virtual resources currently owned in the target space associated with the virtual scene have been searched, or whether the virtual resources currently owned in the target space associated with the virtual scene have specified target virtual resources.

In this embodiment, for example, the historical behavior information of the virtual scene or the target space being operated is historical behavior information of a friendly character (in the same camp) that has been operated in the virtual scene or target space, or historical behavior information of an enemy character (in different camps) that has been operated in the virtual scene or target space.

In this embodiment, for the indication direction information starting from the virtual scene or the target space, for example, when there is a need to instruct a friendly character to move, the friendly character may be instructed to move correctly through transfer of the indication direction information.

In this embodiment, for the reference information for completing a virtual task associated with the virtual scene or the target space, for example, in game scenes that require operations such as decryption and puzzle solving, when the virtual character finds reference information of clues, the reference information may be provided to the friendly character through information transfer.

As an exemplary solution, for ease of understanding, the foregoing information transfer method is applied to a team-type game scene. In some embodiments, based on a SOP system used for communication in real-life special forces, the information communication manner designed for use in the game can not only meet the foregoing situation, but also expand into a systematic communication system for diverse information, which aims to use a virtual item that conforms to a world view of the game as a carrier to meet rationality of information communication needs among teammates. For example, in a realistic game, different quantities and placement patterns of light sticks may be used as information carriers for communication between the users across time dimensions.

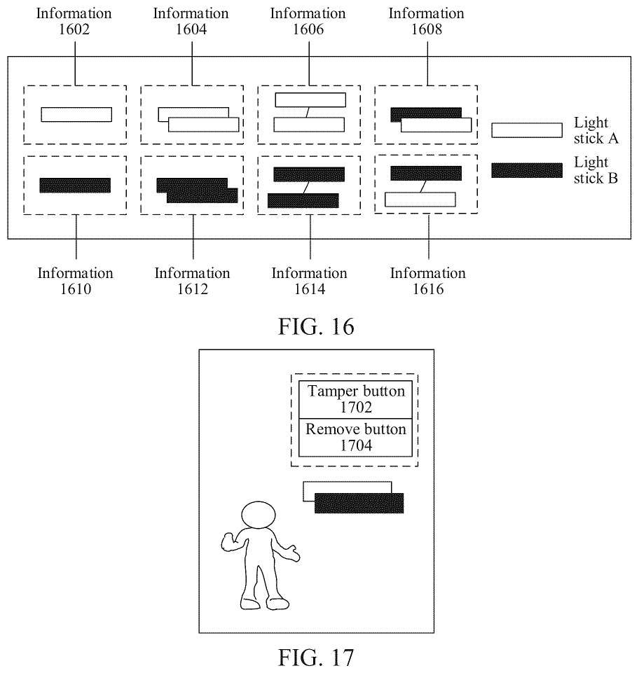

Further, in some embodiments, the light sticks are used as an example. Specifically, for example, as shown in FIG. 16, different states and quantities of light sticks A and light sticks B are used to transfer different information.

Specifically, if a light stick A is placed alone, it is used to transfer information 1602, such as “this region is safe”;
if a light stick A is placed alone, it is used to transfer information 1602, such as “this region is safe”;
if a light stick B is placed alone, it is used to transfer information 1610, such as “this region is dangerous”;
if two light sticks A are placed separately, they are used to transfer information 1604, such as “this region has been searched”;
if two light sticks B are placed separately, they are used to transfer information 1612, such as “this region has not been searched” or “an enemy has come”;
if two light sticks A are placed in connection, they are used to transfer information 1606, such as “a friendly troop is in this direction”;
if two light sticks B are placed in connection, they are used to transfer information 1614, such as “an enemy troop is in this direction” or “warning in this direction”;
if a light stick A and a light stick B are placed separately, they are used to transfer information 1608, such as “safety unknown, stay alert”; and
if a light stick A is placed in connection to a light stick B, they are used to transfer information 1616, such as “this region needs to be inspected”.

In addition, in this embodiment, in addition to light sticks, this embodiment is further applicable to different item carriers of similar or other types of games, such as a memory chip, a secret symbol engraved on a surface, holographic projection, a consciousness body in a fantasy game, and magic. The item carrier in the virtual scene is to make cross-time communication appropriate and does not limit the form.

In this embodiment, virtual item information may be preset by a system or customized by the user according to positioning difference of the game to highly restore the encrypted communication characteristics.

Further, on this basis, a general process of a specific communication manner/implementation of this embodiment includes: a pre-order user leaves a virtual item on site and then leaves, and a post-order user arrives at the site and contacts the item left by the pre-order user to obtain information. There are many possibilities for the way in which the user leaves the item and the way in which the post-order user obtains information, which can be configured according to the game setting, hardcore level, and other factors. Further, for example, if the behavior and the corresponding information are preconfigured, after the user performs the behavior, it is automatically triggered to leave the corresponding virtual item information in the scene. Alternatively, the user can freely choose whether and what information needs to be left in all the preconfigured information lists.

Further, in this embodiment, a receiving information manner may include, but is not limited to: After the post-order user approaches the virtual item left by the pre-order user, the system automatically interprets the corresponding information. After the post-order user approaches the virtual item left by the pre-order user, the post-order user learns the information through active interaction. In some hard-core games, the user can only interpret the virtual item left by the pre-order user through memory.

In this embodiment, as shown in FIG. 17, the virtual item information left on the site may alternatively be set as that an enemy (a non-friendly user) can also obtain or even tamper with the information. For example, information “there is a trap in the house” left by the other party is modified to “this region is safe” by triggering a tamper button 1702 to confuse post-order users; or the information “there is a trap in the house” left by the other party is directly removed by triggering a remove button 1704.

Further, whether anyone in the team has searched for the house in the game is used as an example, and the process is as follows.
S1: A user enters a building and picks up an item inside.
S2: When the user leaves a room, the user automatically (or actively) leaves a light stick mark at a door of the room of the building.
S3: A post-order user enters the building, and after the post-order user sees the light stick, the post-order user can understand that supplies in the building have been picked up by a teammate.
S4: When a teammate does not see the light stick and passes by the light stick, a system automatically pops up a prompt “supplies in this room have been searched by teammates” or the teammate approaches the light stick and interacts with the system to learn what the item represents.

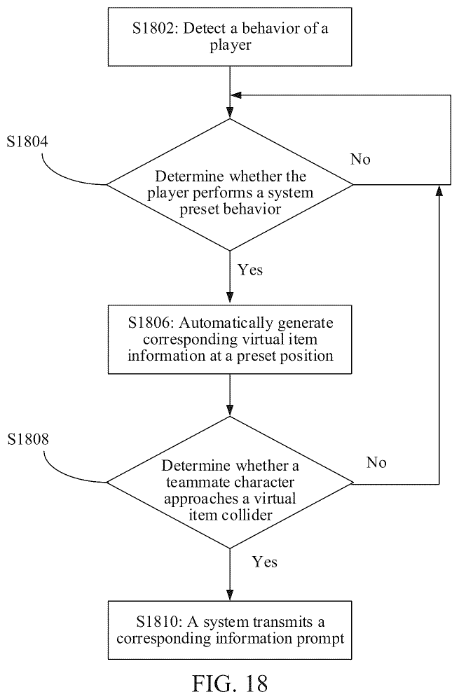

In this embodiment, the virtual item information can be communicated through the configuration of preset information and a virtual item combination without the user performing additional operations, as shown in FIG. 18. The specific operations are as follows:
S1802: A system detects whether a character game behavior of a user conforms to content in preset configuration and each preset piece of information corresponds to a specific quantity of in-game behaviors as a trigger standard. These behaviors are used as characteristic points to identify whether the information is triggered and may be a plurality of actions that need to be met in order, or may meet any situation or meet all situations in no order; and the specific settings are based on characteristic information. When a program detects that the character behavior conforms to a behavioral characteristic point of a piece of information in a preset information database, enter a next process.
S1804: Determine whether a player performs a system preset behavior. If yes, perform S1806. If not, continue to detect, or continue to perform S1802.
S1806: Automatically generate corresponding virtual item information at a preset position. Each behavior in the information base corresponds to a virtual item combination and the corresponding item placement position in a trigger scene. When the system detects that the user has performed a characteristic or behavior required by a piece of information, the virtual item corresponding to the piece of information is generated at the specific position in a current scene. The specific position means that the virtual item corresponding to each piece of information has a fixed placement position in different buildings/scenes. A recording manner in the program is a coordinate value relative to the scene.
S1808: When a teammate approaches a virtual item left by another teammate at a specific distance, the system automatically transmits information corresponding to the virtual item to the teammate, each placed virtual item is set with a default collision value, and the collider is generally an invisible block larger than an actual size of a model and is configured for determining when to interact with the user. When the character model of the user is in contact with the collider, the system is triggered to transmit the information content represented by the virtual item to the user. Therefore, the collider is configured for determining a distance between the user and the virtual item, for example, determining whether there is a teammate character to determine the virtual item collider, if yes, perform S1810, if not, continue to detect, or continue to perform S1802.
S1810: The system transmits a corresponding information prompt.

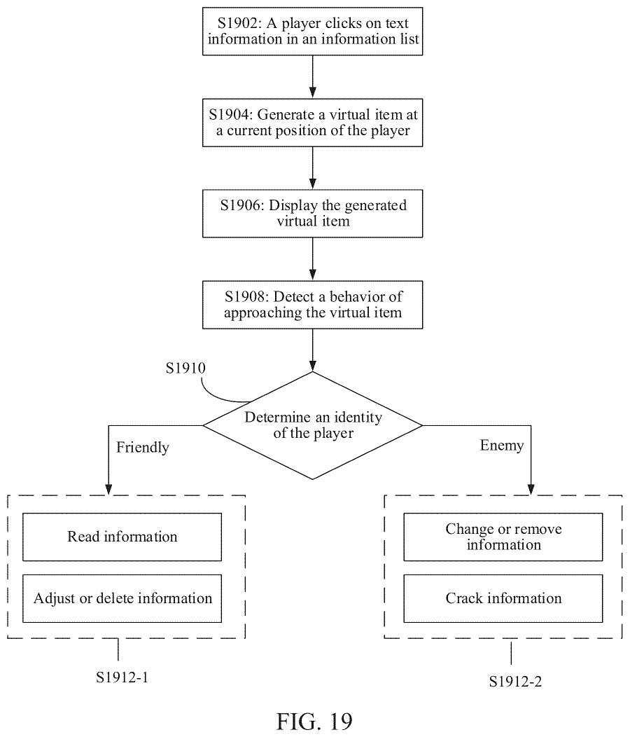

In this embodiment, when the information communication manner based on the virtual item is used as a core system of the game, different identities of the user in the game can perform different operations on the virtual item, as shown in FIG. 19. The specific operations are as follows:
S1902: A player clicks on text information in an information list. Specifically, the user selects any piece of information in a preset virtual item communication system list. Under this setting, the communication information and the corresponding virtual item combination are freely set by the user, and the decryption method is shared with teammates in the team. Specifically, the user can customize the information content and select a representative virtual item form for the information. The program side records the information and adds a characteristic code of the corresponding virtual item to each piece of information. This characteristic code and the selectable virtual item form in the game are preset.
S1904: Generate a virtual item corresponding to information at a current position of the player, after it is confirmed that a user triggers a command, a virtual item corresponding to the command clicked by the user is generated at a current scene position of the user character, and in this case, a program generates a corresponding virtual item into the scene through a virtual item characteristic code corresponding to identification information.
S1906: A generated scene virtual item.
S1908: Approach the virtual item.
S1910: When other users approach the virtual item, a system identifies their identities to determine that each executable interaction that the user can perform has a friendly/neutral/hostile attribute label on a program side. The game provides executable interactive actions based on whether the camps of those who approach the user and those who leave information are consistent. For example, the operations that can be performed are determined based on the identity of the player. If the identity of the player is friendly, perform S1912-1. If the identity of the player is hostile, perform S1912-2.
S1912-1: Read information, and adjust and delete the information. Specifically, when the user approaching the virtual item and the user placing the virtual item are in the same camp, interpretation, editing, removing, or other friendly or neutral behaviors can be performed on the information transferred by the virtual item.
S1912-2: Change or remove the information, and crack the information. Specifically, when the user approaching the virtual item and the user placing the virtual item are from different camps, the user cannot read the true meaning transferred by the item, or can crack the information, or can change the information or remove the item and other hostile or neutral actions.

Through this embodiment of this application, the virtual item in the game that conforms to a game story is used to rationalize the behavior of cross-time communication between the users. This information communication manner based on the virtual item can improve the efficiency of cooperation within the team and strengthen connection between the users. The depth and possibility of gameplay can alternatively be increased by improving the human intervention of the user in the system, so that the cross-time information communication system based on the virtual item has competitive and confrontational attributes.

In a specific implementation of this application, relevant data such as user information is involved. When the foregoing embodiments of this application are applied to specific products or technologies, permission or consent of the user needs to be obtained, and collection, use, and processing of the relevant data need to comply with relevant laws, regulations, and standards of relevant countries and regions.

For ease of description, the foregoing method embodiments are described as a series of action combinations. However, persons skilled in the art should know that this application is not limited to the described order of the actions because some operations may be performed in another order or performed at the same time according to this application. In addition, a person skilled in the art is also to learn that the embodiments described in this specification are all exemplary embodiments, and the involved actions and modules are not necessarily required to this application.

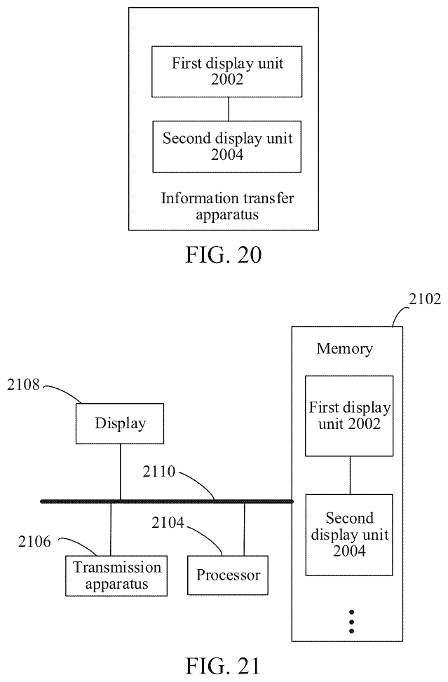

According to another aspect of the embodiments of this application, an information transfer apparatus configured to perform the foregoing information transfer method is further provided. As shown in FIG. 20, the apparatus includes:
a first display unit 2002, configured to display a virtual scene in which a first virtual character is currently located, the virtual scene being a scene in a virtual game in which the first virtual character participates; and
a second display unit 2004, configured to display a first virtual information carrier triggered by the first virtual character in the virtual scene, the first virtual information carrier being configured for transferring information specified by the first virtual character and associated with the virtual scene.

For specific embodiments, reference may be made to the example shown in the foregoing information transfer method. Details are not described again in this example.

As an exemplary solution, the apparatus includes:
a first determining unit, configured to: after the virtual scene in which the first virtual character is currently located is displayed, determine that the first virtual character triggers a first type of information transfer condition when a first operation performed by the first virtual character is obtained, where the information transfer condition is a condition under which the first virtual information carrier is triggered to display.

For specific embodiments, reference may be made to the example shown in the foregoing information transfer method. Details are not described again in this example.

As an exemplary solution, the second display unit 2004 includes:
a first determining module, configured to determine a first type of first virtual information carrier corresponding to the first type of information transfer condition, and a generation position of the first type of first virtual information carrier, where the generation position of the first type of first virtual information carrier is associated with the first operation; and
a first display module, configured to display the first type of first virtual information carrier as the first virtual information carrier at the generation position of the first type of first virtual information carrier.

For specific embodiments, reference may be made to the example shown in the foregoing information transfer method. Details are not described again in this example.

As an exemplary solution, the apparatus includes:
a third display unit, configured to display a virtual carrier interaction information list after the virtual scene in which the first virtual character is currently located is displayed; and
a second determining unit, configured to: after the virtual scene in which the first virtual character is currently located is displayed, determine that the first virtual character triggers a second type of information transfer condition when a second operation performed on target carrier interaction information in the virtual carrier interaction information list is obtained, where the information transfer condition is a condition under which the first virtual information carrier is triggered to display.

For specific embodiments, reference may be made to the example shown in the foregoing information transfer method. Details are not described again in this example.

As an exemplary solution, the second display unit 2004 includes:
a second determining module, configured to determine a second type of first virtual information carrier corresponding to the second type of information transfer condition, and a generation position of the second type of first virtual information carrier, where the generation position of the second type of first virtual information carrier is associated with the second operation; and
a second display module, configured to display the second type of first virtual information carrier as the first virtual information carrier at the generation position of the second type of first virtual information carrier.

For specific embodiments, reference may be made to the example shown in the foregoing information transfer method. Details are not described again in this example.

As an exemplary solution, the apparatus further includes:
a fourth display unit, configured to display a second virtual information carrier in the virtual scene after the virtual scene in which the first virtual character is currently located is displayed, where the second virtual information carrier is an information carrier generated when a second virtual character participating in the virtual game triggers a target information transfer condition, and the second virtual information carrier is configured for transferring information specified by the second virtual character and associated with the virtual scene.

For specific embodiments, reference may be made to the example shown in the foregoing information transfer method. Details are not described again in this example.

As an exemplary solution, the fourth display unit includes at least one of the following:
a third display module, configured to display the second virtual information carrier in the virtual scene when the second virtual character and the first virtual character belong to the same camp; and
a fourth display module, configured to display encrypted information of the second virtual information carrier when the second virtual character and the first virtual character belong to different camps; and display the second virtual information carrier in the virtual scene in response to a first cracking operation on the encrypted information of the second virtual information carrier being successfully performed.

For specific embodiments, reference may be made to the example shown in the foregoing information transfer method. Details are not described again in this example.

As an exemplary solution, the apparatus further includes:
a fifth display module, configured to: after the second virtual information carrier is displayed in the virtual scene, display target information to be transferred by the second virtual information carrier when the first virtual character triggers an information display condition, where the target information is information specified by the second virtual character and associated with the virtual scene.

For specific embodiments, reference may be made to the example shown in the foregoing information transfer method. Details are not described again in this example.

As an exemplary solution, the apparatus includes at least one of the following:
a third determining module, configured to: before the target information to be transferred by the second virtual information carrier is displayed when the first virtual character triggers an information display condition, determine that the first virtual character triggers the information display condition when the second virtual character and the first virtual character belong to the same camp; and
a fourth determining module, configured to: before the target information to be transferred by the second virtual information carrier is displayed when the first virtual character triggers an information display condition, display encrypted information of the target information when the second virtual character and the first virtual character belong to different camps; and determine that the first virtual character triggers the information display condition when a second cracking operation on the encrypted information of the target information being successfully performed.

For specific embodiments, reference may be made to the example shown in the foregoing information transfer method. Details are not described again in this example.

As an exemplary solution, the apparatus includes:
an obtaining module, configured to: before the target information to be transferred by the second virtual information carrier is displayed when the first virtual character triggers an information display condition, obtain a current position of the first virtual character; and
a fifth determining module, configured to: before the target information to be transferred by the second virtual information carrier is displayed when the first virtual character triggers an information display condition, determine that the first virtual character triggers the information display condition when a distance between the current position of the first virtual character and the second virtual information carrier is less than a threshold.

For specific embodiments, reference may be made to the example shown in the foregoing information transfer method. Details are not described again in this example.

As an exemplary solution, the apparatus includes:
a sixth determining module, configured to: before the target information to be transferred by the second virtual information carrier is displayed when the first virtual character triggers an information display condition, determine that the first virtual character triggers the information display condition when the first virtual character collides with the second virtual information carrier.

For specific embodiments, reference may be made to the example shown in the foregoing information transfer method. Details are not described again in this example.

As an exemplary solution, the apparatus includes:
a seventh determining module, configured to: before the target information to be transferred by the second virtual information carrier is displayed when the first virtual character triggers an information display condition, determine that the first virtual character triggers the information display condition when a third operation performed on the second virtual information carrier is obtained.

For specific embodiments, reference may be made to the example shown in the foregoing information transfer method. Details are not described again in this example.

As an exemplary solution, the first display unit 2004 includes:
a sixth display module, configured to display N first virtual information carriers triggered by the first virtual character in the virtual scene, where N is a natural number, and the information specified by the first virtual character and associated with the virtual scene is associated with each of the N first virtual information carriers.

For specific embodiments, reference may be made to the example shown in the foregoing information transfer method. Details are not described again in this example.

As an exemplary solution, the apparatus includes at least one of the following:
an eighth determining module, configured to: after the first virtual information carrier triggered by the first virtual character is displayed in the virtual scene, modify the first virtual information carrier in response to a first modification instruction and display a modified first virtual information carrier in the virtual scene, where information to be transferred by the modified first virtual information carrier is different from the information specified by the first virtual character and associated with the virtual scene; and
a ninth determining module, configured to: after the first virtual information carrier triggered by the first virtual character is displayed in the virtual scene, modify the information specified by the first virtual character and associated with the virtual scene in response to a second modification instruction to obtain modified specified information, and determine that information used by the first virtual information carrier to transfer is modified to the modified specified information.

For specific embodiments, reference may be made to the example shown in the foregoing information transfer method. Details are not described again in this example.

As an exemplary solution, the second display unit 2004 includes at least one of the following:
a seventh display module, configured to display a virtual element mark triggered by the first virtual character in the virtual scene, where the virtual element mark is a virtual mark left after a target element is imprinted on a first target object in the virtual scene;
an eighth display module, configured to display a virtual prop triggered by the first virtual character in the virtual scene, where the virtual prop includes a static prop and a dynamic prop, the dynamic prop allows triggering playback of a virtual picture, and the virtual picture is configured for transferring the information specified by the first virtual character and associated with the virtual scene; and
a ninth display module, configured to display a second target object triggered by the first virtual character in the virtual scene, where the second target object is configured for dynamically transferring the information specified by the first virtual character and associated with the virtual scene.

For specific embodiments, reference may be made to the example shown in the foregoing information transfer method. Details are not described again in this example.

As an exemplary solution, the apparatus includes:
a fifth display unit, configured to: after the first virtual information carrier triggered by the first virtual character is displayed in the virtual scene, display the information specified by the first virtual character and associated with the virtual scene, where the information specified by the first virtual character and associated with the virtual scene includes at least one of the following:
safety information of a current environment of the virtual scene or a target space associated with the virtual scene;
situation information of virtual resources currently owned by the virtual scene or the target space;
historical behavior information of the virtual scene or the target space being operated;
indication direction information starting from the virtual scene or the target space; and
reference information for completing a virtual task associated with the virtual scene or the target space.

For specific embodiments, reference may be made to the example shown in the foregoing information transfer method. Details are not described again in this example.

According to still another aspect of the embodiments of this application, an electronic device configured to perform the foregoing information transfer method is further provided. As shown in FIG. 21, the electronic device includes a memory 2102 and a processor 2104, the memory 2102 having a computer program stored therein, and the processor 2104 being configured to perform the operations in any one of the foregoing method embodiments through the computer program.

In this embodiment, the electronic device may be located in at least one of a plurality of network devices in a computer network.

In this embodiment, the processor may be configured to perform the following operations by executing the computer program.
S1: Display a virtual scene in which a first virtual character is currently located, the virtual scene being a scene in a virtual game in which the first virtual character participates.
S2: Display a first virtual information carrier triggered by the first virtual character in the virtual scene, the first virtual information carrier being configured for transferring information specified by the first virtual character and associated with the virtual scene.

The memory 2102 may be configured to store a software program and module, for example, a program instruction/module corresponding to the information transfer method and apparatus in the embodiments of this application, and the processor 2104 runs the software program and module stored in the memory 2102, to perform various functional applications and data processing, that is, implement the foregoing information transfer method.

A transmission apparatus 2106 is configured to receive or transmit data through a network.

In addition, the electronic device may further include: a display 2108, configured to display information such as the virtual scene, the information transfer condition, and the first virtual information carrier; and a connection bus 2110, configured to connect various module components in the electronic device.

According to an aspect of this application, a computer program product is provided, the computer program product including a computer program/instructions, and the computer program/instructions including program code configured for performing the method shown in the flowchart. In such an embodiment, the computer program may be downloaded and installed from a network through a communication part, and/or installed from a removable medium. When the computer program is executed by a central processing unit, various functions provided in the embodiments of this application are executed.

The sequence numbers of the foregoing embodiments of this application are merely for description purpose, and do not indicate the preference of the embodiments.

A computer system of the electronic device is merely an example, and does not constitute any limitation on functions and use ranges of the embodiments of this application.

Particularly, according to an embodiment of this application, the processes described in the method flowcharts may be implemented as computer software programs. For example, this embodiment of this application includes a computer program product, the computer program product includes a computer program carried on a computer-readable medium, and the computer program includes program code used for performing the methods shown in the flowcharts. In such an embodiment, the computer program may be downloaded and installed from a network through a communication part, and/or installed from a removable medium. When the computer program is executed by a central processing unit, various functions limited in the embodiments of this application are executed.

According to an aspect of this application, a non-transitory computer-readable storage medium is provided. A processor of a computer device reads a computer program from the computer-readable storage medium, and executes the computer program, so that the computer device performs the method provided in the various exemplary implementations above.

In this embodiment, the computer-readable storage medium may be configured to store a computer program configured to perform the following operations.
S1: Display a virtual scene in which a first virtual character is currently located, the virtual scene being a scene in a virtual game in which the first virtual character participates.
S2: Display a first virtual information carrier triggered by the first virtual character in the virtual scene, the first virtual information carrier being configured for transferring information specified by the first virtual character and associated with the virtual scene.

In this embodiment, a person of ordinary skill in the art may understand that all or some of the operations of the various methods in the foregoing embodiments may be implemented by a program instructing relevant hardware. The program may be stored in a non-transitory computer-readable storage medium. The storage medium may include: a flash drive, a Read-Only Memory (ROM), a Random Access Memory (RAM), a magnetic disk, an optical disc, and the like.

When the integrated unit in the foregoing embodiments is implemented in the form of a software function unit and sold or used as an independent product, the integrated unit may be stored in the foregoing computer-readable storage medium. Based on such an understanding, the technical solutions of this application essentially, or a part contributing to the related art, or all or a part of the technical solution may be implemented in a form of a software product. The computer software product is stored in a storage medium and includes several instructions for instructing one or more computer devices (which may be a PC, a server, a network device, or the like) to perform all or some of operations of the methods in the embodiments of this application.

In the foregoing embodiments of this application, the descriptions of the embodiments have respective focuses. For a part that is not described in detail in an embodiment, reference may be made to related descriptions in other embodiments.

In the several embodiments provided in this application, the disclosed client may be implemented in other manners. The described apparatus embodiments are merely exemplary. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electronic or another form.

The units described as separate parts may or may not be physically separate, and parts displayed as units may or may not be physical units, may be located in one position, or may be distributed on a plurality of network units. Some or all of the units may be selected based on actual requirements to achieve the objectives of solutions of embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

The foregoing descriptions are merely preferred embodiments of the present invention, and a person of ordinary skill in the art may make various improvements and modifications without departing from the spirit of the present disclosure. All such improvements and refinements shall fall within the protection scope of the present disclosure. In this application, the term “module” or “unit” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules (or units).

What is claimed is:

1. An information transfer method performed by an electronic device, the method comprising:
displaying a virtual scene of a virtual game in which a first virtual character is currently located;
in accordance with a first operation performed by the first virtual character, determining that the first virtual character triggers a first type of information transfer condition; and
in accordance with the first type of information transfer condition, displaying a first virtual information carrier in the virtual scene, the first virtual information carrier being configured for transferring information specified by the first virtual character and associated with the virtual scene to a second virtual character.

2. The method according to claim 1, wherein the displaying a virtual scene of a virtual game in which a first virtual character is currently located comprises:
determining a first type of virtual information carrier corresponding to the first type of information transfer condition, and a generation position of the first type of virtual information carrier associated with the first operation; and
displaying the first type of virtual information carrier as the first virtual information carrier at the generation position of the first type of virtual information carrier.

3. The method according to claim 1, wherein after the displaying a virtual scene of a virtual game in which a first virtual character is currently located, the method further comprises:
displaying a virtual carrier interaction information list; and
determining that the first virtual character triggers a second type of information transfer condition when a second operation performed on target carrier interaction information in the virtual carrier interaction information list is obtained, wherein the information transfer condition is a condition under which the first virtual information carrier is triggered to display.

4. The method according to claim 1, wherein after the displaying a virtual scene of a virtual game in which a first virtual character is currently located, the method further comprises:
displaying a second virtual information carrier in the virtual scene, wherein the second virtual information carrier is an information carrier generated when a second virtual character participating in the virtual game triggers a target information transfer condition, and the second virtual information carrier is configured for transferring information specified by the second virtual character and associated with the virtual scene.

5. The method according to claim 1, wherein the displaying a first virtual information carrier in the virtual scene comprises:
displaying a plurality of first virtual information carriers triggered by the first virtual character in the virtual scene, wherein the information specified by the first virtual character and associated with the virtual scene is associated with the plurality of first virtual information carriers.

6. The method according to claim 1, wherein after the displaying a first virtual information carrier in the virtual scene, the method further comprises at least one of the following:
modifying the first virtual information carrier in response to a first modification instruction and displaying a modified first virtual information carrier in the virtual scene, wherein information to be transferred by the modified first virtual information carrier is different from the information specified by the first virtual character and associated with the virtual scene; and
modifying the information specified by the first virtual character and associated with the virtual scene in response to a second modification instruction to obtain modified specified information, and determining that information used by the first virtual information carrier to transfer is modified to the modified specified information.

7. The method according to claim 1, wherein the displaying a first virtual information carrier in the virtual scene comprises at least one of the following:
displaying a virtual element mark triggered by the first virtual character in the virtual scene, wherein the virtual element mark is a virtual mark left after a target element is imprinted on a first target object in the virtual scene;
displaying a virtual prop triggered by the first virtual character in the virtual scene, wherein the virtual prop comprises a static prop and a dynamic prop, the dynamic prop allows triggering playback of a virtual picture, and the virtual picture is configured for transferring the information specified by the first virtual character and associated with the virtual scene; and
displaying a second target object triggered by the first virtual character in the virtual scene, wherein the second target object is configured for dynamically transferring the information specified by the first virtual character and associated with the virtual scene.

8. The method according to claim 1, wherein after the displaying a first virtual information carrier in the virtual scene, the method further comprises:
displaying the information specified by the first virtual character and associated with the virtual scene, wherein the information specified by the first virtual character and associated with the virtual scene comprises at least one of the following:
safety information of a current environment of the virtual scene or a target space associated with the virtual scene;
situation information of virtual resources currently owned by the virtual scene or the target space;
historical behavior information of the virtual scene or the target space being operated;
indication direction information starting from the virtual scene or the target space; and
reference information for completing a virtual task associated with the virtual scene or the target space.

9. An electronic device, comprising a memory and a processor, the memory having a computer program stored therein, the computer program, when executed by the processor, causing the electronic device to perform an information transfer method including:
displaying a virtual scene of a virtual game in which a first virtual character is currently located;
in accordance with a first operation performed by the first virtual character, determining that the first virtual character triggers a first type of information transfer condition; and
in accordance with the first type of information transfer condition, displaying a first virtual information carrier in the virtual scene, the first virtual information carrier being configured for transferring information specified by the first virtual character and associated with the virtual scene to a second virtual character.

10. The electronic device according to claim 9, wherein the displaying a virtual scene of a virtual game in which a first virtual character is currently located comprises:
determining a first type of virtual information carrier corresponding to the first type of information transfer condition, and a generation position of the first type of virtual information carrier associated with the first operation; and
displaying the first type of virtual information carrier as the first virtual information carrier at the generation position of the first type of virtual information carrier.

11. The electronic device according to claim 9, wherein after the displaying a virtual scene of a virtual game in which a first virtual character is currently located, the method further comprises:
displaying a virtual carrier interaction information list; and
determining that the first virtual character triggers a second type of information transfer condition when a second operation performed on target carrier interaction information in the virtual carrier interaction information list is obtained, wherein the information transfer condition is a condition under which the first virtual information carrier is triggered to display.

12. The electronic device according to claim 9, wherein after the displaying a virtual scene of a virtual game in which a first virtual character is currently located, the method further comprises:
displaying a second virtual information carrier in the virtual scene, wherein the second virtual information carrier is an information carrier generated when a second virtual character participating in the virtual game triggers a target information transfer condition, and the second virtual information carrier is configured for transferring information specified by the second virtual character and associated with the virtual scene.

13. The electronic device according to claim 9, wherein the displaying a first virtual information carrier in the virtual scene comprises:
displaying a plurality of first virtual information carriers triggered by the first virtual character in the virtual scene, wherein the information specified by the first virtual character and associated with the virtual scene is associated with the plurality of first virtual information carriers.

14. The electronic device according to claim 9, wherein after the displaying a first virtual information carrier in the virtual scene, the method further comprises at least one of the following:
modifying the first virtual information carrier in response to a first modification instruction and displaying a modified first virtual information carrier in the virtual scene, wherein information to be transferred by the modified first virtual information carrier is different from the information specified by the first virtual character and associated with the virtual scene; and
modifying the information specified by the first virtual character and associated with the virtual scene in response to a second modification instruction to obtain modified specified information, and determining that information used by the first virtual information carrier to transfer is modified to the modified specified information.

15. The electronic device according to claim 9, wherein the displaying a first virtual information carrier in the virtual scene comprises at least one of the following:
displaying a virtual element mark triggered by the first virtual character in the virtual scene, wherein the virtual element mark is a virtual mark left after a target element is imprinted on a first target object in the virtual scene;
displaying a virtual prop triggered by the first virtual character in the virtual scene, wherein the virtual prop comprises a static prop and a dynamic prop, the dynamic prop allows triggering playback of a virtual picture, and the virtual picture is configured for transferring the information specified by the first virtual character and associated with the virtual scene; and
displaying a second target object triggered by the first virtual character in the virtual scene, wherein the second target object is configured for dynamically transferring the information specified by the first virtual character and associated with the virtual scene.

16. The electronic device according to claim 9, wherein after the displaying a first virtual information carrier in the virtual scene, the method further comprises:
displaying the information specified by the first virtual character and associated with the virtual scene, wherein the information specified by the first virtual character and associated with the virtual scene comprises at least one of the following:
safety information of a current environment of the virtual scene or a target space associated with the virtual scene;
situation information of virtual resources currently owned by the virtual scene or the target space;
historical behavior information of the virtual scene or the target space being operated;
indication direction information starting from the virtual scene or the target space; and
reference information for completing a virtual task associated with the virtual scene or the target space.

17. A non-transitory computer-readable storage medium, comprising a computer program stored therein, the computer program, when executed by a processor of a computer device, causing the computer device to perform an information transfer method including:
displaying a virtual scene of a virtual game in which a first virtual character is currently located;
in accordance with a first operation performed by the first virtual character, determining that the first virtual character triggers a first type of information transfer condition; and
in accordance with the first type of information transfer condition, displaying a first virtual information carrier in the virtual scene, the first virtual information carrier being configured for transferring information specified by the first virtual character and associated with the virtual scene to a second virtual character.

18. The non-transitory computer-readable storage medium according to claim 17, wherein after the displaying a virtual scene of a virtual game in which a first virtual character is currently located, the method further comprises:
displaying a virtual carrier interaction information list; and
determining that the first virtual character triggers a second type of information transfer condition when a second operation performed on target carrier interaction information in the virtual carrier interaction information list is obtained, wherein the information transfer condition is a condition under which the first virtual information carrier is triggered to display.

19. The non-transitory computer-readable storage medium according to claim 17, wherein after the displaying a virtual scene of a virtual game in which a first virtual character is currently located, the method further comprises:
displaying a second virtual information carrier in the virtual scene, wherein the second virtual information carrier is an information carrier generated when a second virtual character participating in the virtual game triggers a target information transfer condition, and the second virtual information carrier is configured for transferring information specified by the second virtual character and associated with the virtual scene.

20. The non-transitory computer-readable storage medium according to claim 17, wherein after the displaying a first virtual information carrier in the virtual scene, the method further comprises at least one of the following:
modifying the first virtual information carrier in response to a first modification instruction and displaying a modified first virtual information carrier in the virtual scene, wherein information to be transferred by the modified first virtual information carrier is different from the information specified by the first virtual character and associated with the virtual scene; and
modifying the information specified by the first virtual character and associated with the virtual scene in response to a second modification instruction to obtain modified specified information, and determining that information used by the first virtual information carrier to transfer is modified to the modified specified information.
